(19) United States
(12) Patent Application Publication
(10) Pub. No.: US 2004/0042703 A1
(43) Pub. Date: Mar. 4, 2004

(54) Method and apparatus for sensing an environmental parameter in a wellbore

(76) Inventor: Thomas M. Deaton, Houston, TX (US)

Correspondence Address: Schlumberger Technology Corporation, Schlumberger Reservoir Completions, 14910 Airline Road, P.O. Box 1590, Rosharon, TX, 77583-1590, US

(21) Appl. No.: 10/465,494

(22) Filed: Jun. 19, 2003

Related U.S. Application Data
(60) Provisional application No. 60/406,542, filed on Aug. 28, 2002.

(51) Int. Cl. G02B 6/00

(52) U.S. Cl. 385/12

(57) ABSTRACT

An apparatus and method for use in a wellbore includes a sensor having an optical fiber and a strain sensitive member that is continuously bonded to a portion of the optical fiber. The optical fiber portion is strained in response to an environmental parameter of the wellbore that is being monitored by the sensor. The strain on the optical fiber portion changes a property of light signals propagating in the optical fiber.

### CROSS REFERENCE TO RELATED APPLICATION

This claims the benefit under 35 U.S.C. §119(e) of U.S. Provisional Patent Application Serial No. 60/406,542, entitled “Method and Apparatus for Sensing an Environmental Parameter in a Wellbore,” filed Aug. 28, 2002.

### TECHNICAL FIELD

This invention relates to methods and apparatus for sensing environmental parameters in wells for the production of petroleum products.

### BACKGROUND

Wells for the production of petroleum products are drilled through the earth's subsurface. Wellbores may be vertical, deviated, or horizontal and may or may not be lined with a casing or other liner. Various operations are performed in the wellbore to complete the well as well as to produce hydrocarbons from target reservoirs. For example, a perforating gun can be lowered into the wellbore and fired to perforate openings through any surrounding casing or liner and to extend perforations into a surrounding reservoir. Also, valves and pumps are installed in the wellbore to control flow of hydrocarbons.

In performing operations in a wellbore, environmental parameters of the wellbore and/or the surrounding formation may be monitored. For example, temperature and pressure within the wellbore may be monitored. Wellbore temperature and pressure may be monitored in the vicinity of downhole equipment such as submersible pumps and logging modules to provide equipment operators with information regarding the equipment's performance. Moreover, pressure measurements in particular may be used to keep the equipment operating at peak performance levels, which in turn, improves the efficiency and longevity of the equipment. Downhole pressures may also be monitored during water, steam and carbon dioxide injection, drilling operations, or to optimize hydrocarbon extraction from the wellbore.

Conventional sensors are susceptible to electromagnetic noise or may be susceptible to damage due to the harsh environment in a wellbore. Moreover, conventional sensors may be unsafe under certain conditions and may be costly to maintain. Thus, there is a continuing need for improved methods and apparatus to sense environmental parameters within and surrounding a wellbore.

### SUMMARY

In general, according to one embodiment, a system for using a wellbore comprises a device adapted to perform an operation in the wellbore and a sensor adapted to sense pressure in the wellbore. The sensor includes a strain sensitive member, and an optical fiber having a portion that is bonded to the strain sensitive member. The sensor further includes a housing defining a first chamber, the housing attached to the strain sensitive member. The first chamber is at a first pressure. The sensor further includes a second chamber proximate to the first chamber, with the second chamber at a second pressure.

Other or alternative features will become apparent from the following description, from the drawings, and from the claims.

### BRIEF DESCRIPTION OF THE DRAWINGS

FIG. 1 illustrates a fiber optic pressure sensor assembly according to one embodiment of the present invention;

FIG. 2 illustrates a fiber optic pressure sensor assembly according to an alternate embodiment of the present invention;

FIG. 3 is an enlarged cross-sectional view of the fiber optic sensor for use with the assembly of FIG. 1 or FIG. 2;

FIG. 4 is an enlarged cross-sectional view of the fiber optic sensor according to an alternate embodiment for use with the assembly of FIG. 1 or FIG. 2.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible.

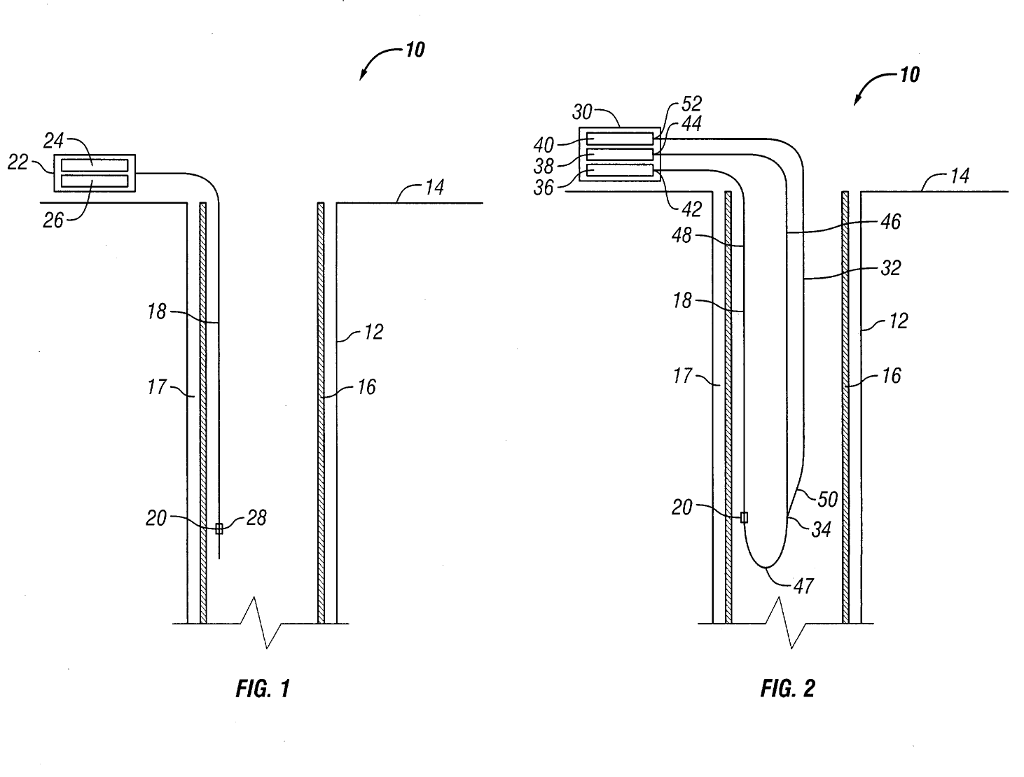

Referring to FIG. 1, a fiber optic sensor assembly 10 may be utilized to measure an environmental parameter such as temperature or pressure at various depths within a wellbore 12. The assembly 10 may be utilized alone or in conjunction with downhole equipment. Moreover, the subsurface or distal portion of the assembly 10 may lie within a casing 16 or an annular space 17 between the casing 16 and the wellbore 12 wall. Further, in some embodiments, the assembly 10 may be fixed to either the interior or exterior wall of the casing 16. For purposes of clarity, the assembly 10 of FIG. 1 is shown alone and suspended within the interior of the casing 16.

The assembly 10 includes equipment 22 located at the earth's surface 14, an optical fiber 18 and a pressure sensor 20. The surface equipment 22 includes a light source 24 such as a light-emitting diode (LED) or laser diode and equipment 26 suitable for processing a returned light signal. The light source 24 produces a light signal such as a pulse of light that is transmitted into the fiber 18. The processing equipment 26 evaluates the light signal that is returned from the sensor 20 via fiber 18 to determine the measured environmental parameter (e.g., pressure or temperature).

The proximal end of the optical fiber 18 is coupled or in close proximity to the light source 24. Thereafter, the fiber 18 descends to a depth within the wellbore 12. Thus, in this embodiment, the fiber 18 originates at the surface 14 and terminates within the wellbore 12. In other embodiments, the equipment 22 may be positioned downhole in the wellbore. In this case, information pertaining to the measured environmental parameter.

The fiber 18 has a light or wave-guiding core that guides a light signal from the proximal end of the fiber 18 to the distal end of the fiber 18. Typically, the optical fiber 18 includes two concentric layers of highly purified glass, such as silica glass, known as the core and the cladding. Generally, the cladding has a lower refractive index thereby confining light signals to the core of the fiber 18. Although most optical fibers are glass, some suitable fibers may be made from plastic.

In some embodiments, a sheath for support and/or protection may surround the outside of the fiber 18. The sheath may be multi-layered, including strengthening and insulating layers made from materials such as polyvinyl chloride (PVC), stainless steel and the like. In this way, the fiber 18 may be prepared to withstand the harsh environment of a wellbore.

The sensor 20 is positioned at a point on the subsurface portion of the optical fiber 18. Although only one sensor 20 is shown in the embodiment depicted in FIG. 1, several sensors 20 may be distributed along the subsurface length of the fiber 18. When several of the point sensors 20 are arranged on the fiber 18, the sensors 20 may be multiplexed using time divisional multiplexing (TDM), wavelength divisional multiplexing (WDM), or frequency divisional multiplexing (FDM). In this way, multi-point sensing may be achieved.

Generally, a fiber optic sensor modulates a property of a light signal such as its wavelength, frequency or polarization. That is, fiber optic sensors may act as transducers that convert a measurement such as strain into an altered light signal. In embodiments of the present invention, the sensor 20 subjects the fiber 18 to strain in response to downhole environmental parameters, such as pressure, temperature, and so forth. Thus, a property of the light signal is altered.

In some embodiments of the present invention, a sensor element 28 is disposed within the pressure sensor 20. For example, the sensor element 28 may be a diffraction grating, such as a Bragg grating. Generally, diffraction gratings are reflective surfaces having parallel grooves that are closely spaced. In the case of Bragg gratings, the optical fiber is exposed to intense ultraviolet light to produce grooves in the core of the fiber. The spacing between the grooves determines which wavelength of light is reflected back along the length of the fiber. Thus, Bragg gratings with different groove spacing will reflect back different wavelengths or frequencies of light. Wavelengths of light that are not reflected move though the grating.

As stated above, the sensor 20 subjects the fiber 18 to strain. Specifically, the sensor 20 is responsive to an environmental parameter such as pressure and/or temperature that causes the sensor 20 to compress or elongate a portion of the fiber 18 in the axial direction. In embodiments of the present invention that utilize Bragg gratings 28, strain on the fiber 18 causes the spacing between the grooves of the grating 28 to be altered. Accordingly, the wavelength of light back-reflected by the grating 28 in the strained fiber 18 will be different from the wavelength of light back-reflected by the grating 28 in the fiber 18 that is not strained or placed under a reference strain. Because the strain on the fiber 18 is directly related to the wavelength of back-reflected light, the environmental parameter to be sensed can be quantified.

Thus, according to some embodiments of the present invention, a light signal generated by the light source 24 is guided to the subsurface portion of the fiber 18 where the sensor 20 is positioned. In response to the pressure within the wellbore 12, the sensor 20 strains the fiber 18 in the axial direction. The strain causes the preset spacing between the grooves of the grating 28 to either compress or expand. In turn, the change in grating 28 spacing causes a change in the wavelength of light reflected by the grating 28 back to the earth's surface 14. Wavelengths of light that are not back-reflected pass through the grating 28 and continue on through the fiber. To reduce back reflection of the non-reflected light, the most distal end of the fiber 18 may be cut at an angle or treated with an antireflective coating.

The wavelength or frequency of light reflected back to the earth's surface 14 may be monitored by any known technique, such as spectroscopy, optical filtering, tracking with a tunable filter, or detecting with an interferometer. In this way, the wellbore 12 pressure and/or temperature (or other downhole environmental parameter) at the point where the sensor 20 is positioned may be determined.

Referring to FIG. 2, an alternate embodiment of the fiber optic sensor assembly 10 includes surface equipment 30, a fiber 18 having two arms 48 and 46, a collecting fiber 32, a sensor 20 and a beam splitter 34. The surface equipment 30, located at the earth's surface 14, includes two light sources 36 and 38 and analysis equipment 40. One light source 36 or 38 may be a dye laser pumped by a Q-switched, frequency-doubled Nd: YAG laser, as an example. The other light source 36 or 38 may also be a dye laser, such as a continuous wave Argon-pumped dye laser. Each light source 36 and 38 transmits a light signal into an end 42 and 44, respectively, to travel through arms 48 and 46 of the fiber 18. Counter propagating light signals propagate down the fiber 18 and meet at an area of interaction. The analysis equipment 40 may be any suitable equipment to analyze a light signal returned to the earth's surface 14 via fiber 32 (such as a Glan Thompson analyzer or a photodetector).

The fiber 18 of this embodiment is a polarization maintaining fiber such as a birefringent fiber. Generally, a highly birefringent fiber has different refractive indices for two orthogonal linear directions of optical polarization. In some embodiments, the core and cladding of the fiber 18 may have different strain-optic properties. Each end 42 and 44 of the fiber 18 is coupled or in close proximity to the light source 36 and 38 respectively whereas the bend 47 of the fiber 18 (at which the arms 48 and 46 meet) is at a depth within the wellbore 12. Thus, each arm 46 and 48 of the fiber 18 extends from a light source 36 and 38 respectively to the bend 47.

The fiber 32 is also a polarization maintaining fiber that may or may not have a core and cladding with different strain-optic properties. The distal end 50 of the fiber 32 is coupled to one arm 46 or 48 of the fiber 18 by the splitter 34 whereas the proximal end 52 of the fiber 32 is coupled to the analyzer 40.

The beam splitter 34 is disposed on one arm 46 or 48 of the fiber 18 and is proximate to fiber 32. The beam splitter 34 reflects the light signal that is generated after the two counter-propagating waves of light traveling down the arms 46 and 48 interact. That is, the beam splitter 34 reflects the light signal that results from the interaction of the two light signals launched from light sources 36 and 38 onto the collecting fiber 32.

The sensor 20 is disposed on the arm 46 or 48 of the fiber 18 opposite that of the beam splitter 34. In some embodiments, the sensor 20 and beam splitter 34 are separately housed. However, in other embodiments the sensor 20 and beam splitter 34 are enclosed within the same housing. As with other embodiments of the present invention, the sensor 20 strains the fiber 18, which alters a property of a light signal.

According to some embodiments, the sensor 20 modulates the local birefringence of the fiber 18. For example, a pulse of light that is linearly or circularly polarized is launched from light source 36 into arm 48 of the fiber 18. This polarization state is maintained as the pulse is guided down fiber 18 to sensor 20. The sensor 20 strains the fiber 18, which alters the birefringence of the light signal. Thus, the light pulse that exits the sensor 20 is altered from its original form.

The modulated light may be probed with a second light signal that is either co-propagating or counter-propagating. In some embodiments of the present invention, a counter-propagating wave is utilized to probe the sensor 20 modulated light signal. However, the assembly 10 may be adapted to utilize a co-propagating wave to probe the modulated light signal. The counter-propagating light signal is launched from the light source 38 into the arm 46 of the fiber 18. The counter-light signal is the same wavelength as the light signal originally launched from light source 36. Moreover, the counter-signal may be linearly polarized at an angle to the fiber's 18 birefringent axes. At the region of interaction on the fiber 18, the sensor 20 modulated light signal and the counter-light signal interact and couple. For example, if the sensor 20 does not modulate the original light signal, the coupled power is maintained. However, if the original light signal is sensor 20 modulated, then there will be an oscillatory variation in the signal power that emerges from the region of interaction. This variation may be measured as a shift in beat length frequency as a result of time. This shift in frequency is indicative of the strain placed on the fiber 18 by the sensor 20. Thus, the emerging light signal is reflected into fiber 32, by beam splitter 34, which is returned to the earth's surface 14 for analysis.

In an alternate embodiment, the strain on the fiber 18 is measured by the ratio of the pulse energy before and after the interaction of the counter-propagating pulses. For example, if the original light signal and the counter-light signal begin with equal energies and remain unaltered, the interaction between the signals will be relatively great. As a result, the ratio will be small because only a portion of the original energy remains after the interaction. However, if the sensor 20 alters the original light signal, then the ratio will large due to the negligible interaction between the modified signal and the counter-signal. The beam splitter 34 may reflect the post-interaction signal onto the fiber 32, which carries the signal to the earth's surface 14 for analysis.

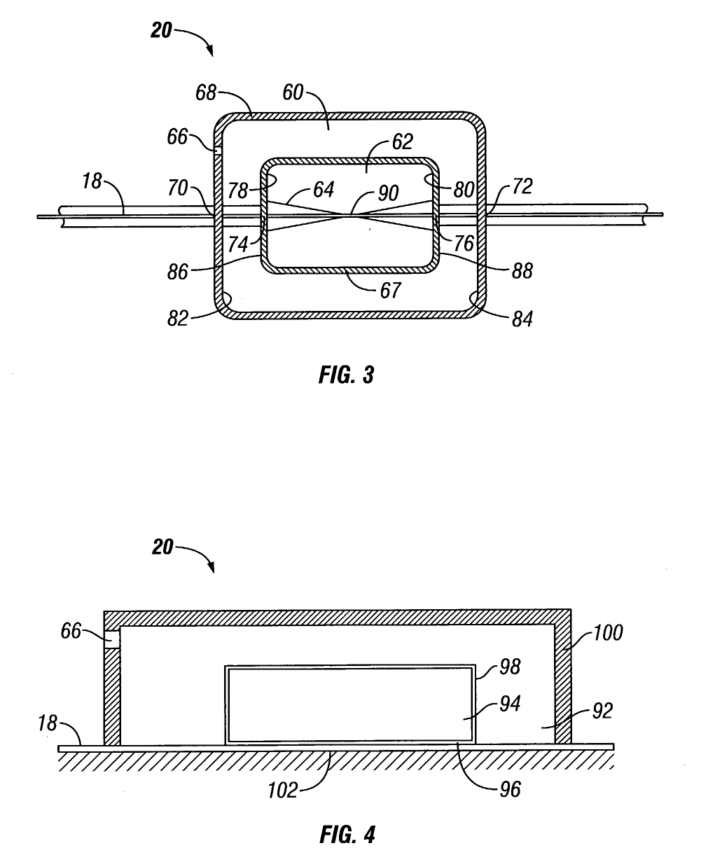

Referring to FIG. 3, according to some embodiments, the sensor 20 includes an open chamber 60 (“open” or in communication with the wellbore environment), a sealed chamber 62 and a strain sensitive member 64 that envelops a portion of the fiber 18. In embodiments where the fiber 18 is supported and/or protected by a sheath, the portion of the fiber 18 enclosed within the sensor 20 may have the sheath removed.

The open chamber 60 is in communication with the wellbore 12 via an inlet 66. Thus, the environmental parameter to be sensed permeates the chamber 60. In some embodiments, the inlet 66 may include a bellows. In another embodiment, the inlet 66 includes a port. An outer housing 68 that defines the open chamber 60 has two openings 70 and 72 for the fiber 18 to traverse the sensor 20. The housing 68 may be made from any rigid material (such as plastic or metal) capable of withstanding the environmental conditions present in the wellbore 12.

In this embodiment, the chamber 62 is enclosed by chamber 60 and is substantially sealed. That is, chamber 62 is not in communication with the open chamber 60, hence the wellbore 12. Although the chamber 62 has openings 74 and 76 for the fiber 18 to pass through, the openings 74 and 76 are sufficiently sealed to prevent exchange of fluids between chambers 60 and 62. The openings 74 and 76 may be sealed in any conventional manner. An inner housing 67 that defines sealed chamber 62 may be made from a material that allows the chamber 62 to expand or contract in the axial direction, such as a flexible metal.

The strain sensitive member 64 supports the fiber 18 portion as it traverses through the sensor 20. Generally, the member 64 is bonded to the interior walls 78 and 80 of housing 67 and extends between the two openings 74 and 76. Moreover, in some embodiments, the member 64 may be bonded to the interior walls 82 and 84 of housing 68 and extend to the exterior walls 86 and 88 of the inner housing 67. In this way, the member 64 may extend across the entire length of the sensor 20. The member 64 may be bonded to the walls 78, 80, 82, 84, 86 and 88 of the housings 67 and 68 by any known means such as with an adhesive.

The length of the fiber 18 portion that traverses the sealed sensor 20 is continuously bonded to the member 64. Continuous bonding of the fiber 18 to the member 64 increases the sensitivity of the sensor 20 to downhole environmental conditions. The optical fiber 18 portion is bonded continuously to the strain sensitive member 64 at least substantially along the entire length of the chamber 60. The length of the chamber 60 is defined along its longitudinal axis between a first end and second end of the chamber 60. The optical fiber 18 portion is generally parallel to the longitudinal axis of the chamber 60 as the optical fiber 18 portion extends through the chamber 60. In the illustrated example of FIG. 3, the fiber 18 portion is also continuously bonded to the strain sensitive member 64 in the region outside the first chamber 60.

The material that the member 64 is made from may also enhance the sensitivity of the sensor 20. For example, the member 64 may be made from a material that has a desirable modulus of elasticity in the direction of the axis of the fiber 18. In some embodiments, the member 64 may be made from an anisotropic material having a lower modulus of elasticity in the axial direction than in the circumferential direction. In other embodiments, the member 64 may be made from a carbon fiber material with a similar coefficient of expansion as the fiber 18. Alternatively, the member 64 can also be made of epoxy or PEEK.

A strain point 90 is typically, approximately at the midpoint of member 64. The strain point 90 is the point at which the relative strain on the fiber 18 portion is the largest. In some embodiments, the sensing element 28 (e.g., Bragg grating) may be located at the strain point 90. Alternately, the sensing element 28 may be disposed proximate the strain point 90.

The sealed chamber 62 may be at a reference pressure or contain a vacuum. A pressure differential created between chambers 60 and 62 causes the member 64 to strain the fiber 18 axially. According to some embodiments of the present invention, a strain on the fiber 18 portion induces a change in a property of a light signal. For example, in embodiments that include the Bragg grating 28, the strain on the fiber 18 portion induced by the strain sensitive member 64 will determine the spacing between the grooves of the grating 28. The wavelength of light that is back-reflected by the grating 28 is space dependent. Thus, the magnitude of the strain is indicated by the wavelength of light that is reflected back to the earth's surface 14.

In other embodiments, for embodiments including a highly birefringent fiber 18, the strain on the fiber 18 portion induced by the strain sensitive member 64 alters the local birefringence of the fiber 18. Thus, variations in the coupling of counter propagating waves may be detected as a shift in frequency due to the strain on the fiber 18. The detected shift in the frequency of the returned wave is indicative of the strain placed on the fiber 18. Alternately, variations in the coupling of counter propagating waves may be detected as the energy remains that after cross-coupling.

The amount of strain on the fiber 18 portion is an interaction of the pressure differential between the open chamber 60 and sealed chamber 62.

Referring to FIG. 4, an alternate embodiment of the sensor 20 also includes an open chamber 92, a sealed chamber 94 and a strain sensitive member 96. However, in this embodiment, the strain sensitive member 96 is one wall of the housing 98 that defines the chamber 94.

As with other embodiments, the open chamber 92 is in communication with the wellbore 12 via an inlet 66. Moreover, the sealed chamber 94 is at a reference pressure or a vacuum. In some embodiments, the chamber 92 encloses chamber 94. Alternately, the chamber 92 may be proximate to chamber 94. In either embodiment, when the parameter to be sensed permeates the chamber 94, a pressure differential is created between the two chambers 92 and 94.

The housing 100 that defines chamber 92 may be of a sufficiently rigid, non-corrosive material such as a plastic or metal. However, the housing 98 that defines chamber 94 is made from a material having a desired modulus of elasticity along the axis of the fiber 18. Thus, the pressure differential between chambers 92 and 94 causes the housing 98 to be strained in the axial direction of the fiber 18.

The optical fiber 18 portion in the sensor is continuously bonded to wall 96 of the housing 98. Thus, in this embodiment, the strain sensitive member is a wall of the housing 100 defining the reference chamber 94. The wall is continuously bonded to the fiber 18 portion along substantially the entire length of the chamber 94 between its first and second ends along the longitudinal direction of the chamber 94.

The fiber 18 portion is also strained axially in response to the pressure differential between chambers 92 and 94. In some embodiments the fiber 18 is also continuously bonded to the housing 98. The fiber 18 portion can either be in direct contact with the housing 98, or an adhesive layer may be provided between the fiber 18 portion and the housing 98. As examples, the adhesive layer includes epoxy, PEEK and the like.

A strain point 102 lies approximately at the midpoint of wall 96. As with other embodiments, the strain point 102 is the point wherein the strain on the fiber line 18 portion is maximized. Likewise, the strain point 102 may include the element 28, or alternately, the element 28 may be proximate the strain point 102. Strain on the fiber 18 due to the pressure differential between chambers 92 and 94 induces a change in a property of the light signal being monitored as previously described.

While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A system for use in a wellbore, comprising:
a device adapted to perform an operation in the wellbore;
an optical fiber; and
a sensor adapted to sense pressure in the wellbore, the sensor comprising:
a strain sensitive member, the optical fiber having a portion that is bonded to said strain sensitive member;
a housing defining a first chamber having a length between a first end and second end of the first chamber, the housing attached to said strain sensitive member, said first chamber at a first pressure,
the optical fiber portion bonded continuously to the strain sensitive member substantially along the entire length of the first chamber; and
a second chamber proximate to said first chamber, said second chamber at a second pressure.

2. The system of claim 1, wherein the first chamber has a longitudinal axis, the optical fiber portion extending through the sensor generally in parallel to the longitudinal axis of the first chamber.

3. The system of claim 2, wherein the optical fiber portion extends through the first chamber, the strain sensitive member being bonded to the optical fiber portion inside the chamber.

4. The system of claim 2, wherein the strain sensitive member is part of the housing, the optical fiber portion being bonded to an outer surface of the housing.

5. The system of claim 1, further comprising a strain point on said portion of said the optical fiber portion that is continuously bonded to said strain sensitive member.

6. The system of claim 5, further comprising a Bragg grating proximate to said strain point.

7. The system of claim 1, further comprising a first light source coupled to an end of said optical fiber to introduce a first light signal.

8. The system of claim 7, further comprising a second light source coupled to the opposite end of said fiber to introduce a second light signal.

9. The system of claim 8, further comprising a second optical fiber in communication with said optical fiber to guide a light signal that results from the interaction of said first and second light signals.

10. The system of claim 1, further comprising a pressure inlet in said second chamber.

11. The system of claim 1, wherein a wall of the housing said first chamber is said strain sensitive member.

12. The system of claim 1, wherein said optical fiber is a highly birefringent fiber.

13. The system of claim 1, wherein said strain sensitive member is housed by said first chamber.

14. The system of claim 1, wherein said first chamber is at a reference pressure.

15. The system of claim 14, wherein said second chamber is at a pressure to be sensed.

16. The system of claim 15, wherein said strain sensitive member is strained axially in response to said pressure to be sensed.

17. The system of claim 1, wherein the optical fiber portion is strained by a pressure difference between the first and second chambers.

18. A method for sensing an environmental parameter of a wellbore comprising:
launching two counter propagating light signals in the opposite ends of a first optical fiber that extends into the wellbore;
providing a sensor to strain a portion of the first optical fiber in response to the environmental parameter of the wellbore; and
detecting a change in a property of the light signals due to the strain placed on said first optical fiber portion.

19. The method of claim 18, further comprising providing a second optical fiber in communication with said first optical fiber to guide a light signal that results from the interaction of the two counter propagating light signals.

20. The method of claim 19, wherein detecting a change in the property comprises detecting a shift in light frequency.

21. The method of claim 19, wherein detecting a change in the property comprises detecting a loss of light energy.

22. The method of claim 18, wherein providing a sensor that strains the first optical fiber portion comprises providing a sensor that strains the fiber portion by compressing the fiber portion axially.

23. The method of claim 22, wherein launching the counter propagating light signals in the two ends of the first optical fiber comprises launching counter propagating light signals in a polarization maintaining fiber.

24. The method of claim 18, further comprising the sensor sensing pressure in the wellbore.

25. The method of claim 18, further comprising bonding a strain sensitive member to the first optical fiber portion, the strain sensitive member to strain in an axial direction in response to the sensed environmental parameter.

26. A method for sensing an environmental parameter of a wellbore, comprising:
continuously bonding a portion of an optical fiber to a strain sensitive member;
attaching said strain sensitive member to a housing defining a substantially sealed chamber;
wherein continuously bonding the optical fiber portion to the strain sensitive member comprises continuously bonding the optical fiber portion along substantially an entire length of the sealed chamber;
exposing the exterior surface of said housing to the environmental parameter of the wellbore; and
straining said optical fiber portion in response to said exposure of the housing to said environmental parameter.

27. The method of claim 26, further comprising extending the optical fiber portion generally in parallel with a longitudinal axis of the sealed chamber.

28. The method of claim 26, further comprising providing a second chamber that encompasses said sealed chamber, and internally exposing said second chamber to said environmental parameter.

29. The method of claim 28, further comprising launching at least one pulse of light into said optical fiber.

30. The method of claim 29, further comprising detecting a light signal indicative of said strain placed on said fiber portion.

31. The method of claim 28, further comprising providing a Bragg grating on said portion of said fiber that is continuously bonded to said member.

32. The method of claim 31, wherein detecting a light signal comprises detecting a wavelength of light that is reflected from said Bragg grating.

33. The method of claim 31, further comprising, in response to said strain on said fiber portion, reflecting a wavelength of light that is different from the wavelength of light reflected by the Bragg grating in an unstrained fiber.

34. The method of claim 30, wherein detecting the light signal comprises detecting a change in frequency.

35. The method of claim 30, wherein detecting the light signal comprises detecting a change in light energy.

36. The method of claim 28, further comprising providing a pressure inlet.

37. The method of claim 26, wherein continuously bonding a portion of an optical fiber comprises continuously bonding a portion of a polarization maintaining fiber to said member.
